(19) United States
(12) Patent Application Publication
(10) Pub. No.: US 2009/0097079 A1
(43) Pub. Date: Apr. 16, 2009

(54) Image reading device, recording medium storing image reading program, image reading method and data signal

(75) Inventors: Hidetaka Hama, Saitama (JP); Kouji Yorimoto, Saitama (JP); Junichi Goto, Saitama (JP); Kenji Nomura, Saitama (JP); Kazuhiko Minowa, Tokyo (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/081,816

(22) Filed: Apr. 22, 2008

(30) Foreign Application Priority Data
Oct. 15, 2007 (JP) 2007-267852

(51) Int. Cl. H04N 1/04

(52) U.S. Cl. 358/488

(57) ABSTRACT

An image reading device, which includes: an original document reading section that emits light to an original document and in the vicinity of the original document, receives reflected light and outputs image signals; an original document positioning guide that has at least a first color and a second color on a side receiving the light emitted from the original document reading section, and is used for settling a position of the original document; a detection section that monitors a first image signal in a scanning direction from the first color to the original document and a second image signal in a scanning direction from the second color to the original document, and detects a position for extracting image signals corresponding to the light reflected on the original document on the basis of a change occurring in either of the first image signal or the second image signal.

### CROSS-REFERENCE TO RELATED APPLICATION

This application is based on and claims priority under 35 USC 119 from Japanese Patent Application No. 2007-267852 filed on Oct. 15, 2007.

### BACKGROUND

1. Technical Field

The present invention relates to an image reading device, a recording medium storing an image reading program, an image reading method and a data signal.

2. Related Art

In a conventional image reading device (e.g. scanner) that scans and reads an original document placed on a platen, an edge of the original document is matched with a reading start position by placing the original document to an original document positioning guide provided to the platen of the image reading device. However, a slight positional difference between the edge of the original document and the reading start position has frequently occurred. Such positional difference, for example, occurs due to a mechanical deterioration with time or exists even at the time of shipment from a factory. If the reading start position is displaced, for example, if the reading start position exists in the outside of the edge of the original document, image reading is performed for the inside of the original document positioning guide. As a result, the actual read image has a black band corresponding to a portion where the image reading is performed for the portion of the original document positioning guide, resulting in a poor-quality reading image.

### SUMMARY

A first aspect of the present invention provides an image reading device, which includes: an original document reading section that emits light to an original document and in the vicinity of the original document, receives reflected light and outputs image signals; an original document positioning guide that has at least a first color and a second color on a side receiving the light emitted from the original document reading section, and is used for settling a position of the original document; a detection section that monitors a first image signal in a scanning direction from the first color to the original document and a second image signal in a scanning direction from the second color to the original document, and detects a position for extracting the image signals corresponding to light reflected on the original document on the basis of a change occurring in either of the first image signal or the second image signal.

### BRIEF DESCRIPTION OF THE DRAWINGS

An exemplary embodiment of the present invention will be described in detail based on the following figures, wherein:

FIGS. 1A and 1B are diagrams showing one example of an original document holder for setting an original document to be read by the image reading device;

FIG. 2 is a diagram explaining an output of an image signal from a reading section;

FIG. 3 is a diagram showing an example of a functional configuration of the image reading device;

FIGS. 4A and 4B are diagrams explaining an example of processing of detecting an original document reading position when the image reading device reads an original document having a white background;

FIGS. 5A and 5B are diagrams explaining an example of processing of detecting the original document reading position when the image reading device reads an original document having a black background; and

FIG. 6 is a flowchart showing an example flow of processing of detecting an original document reading position implemented by an original document reading position detection section.

### DETAILED DESCRIPTION

Hereinbelow, an exemplary embodiment of an image reading device, a recording medium storing an image reading program, an image reading method and a data signal according to the present invention will be described in detail with reference to the attached drawings.

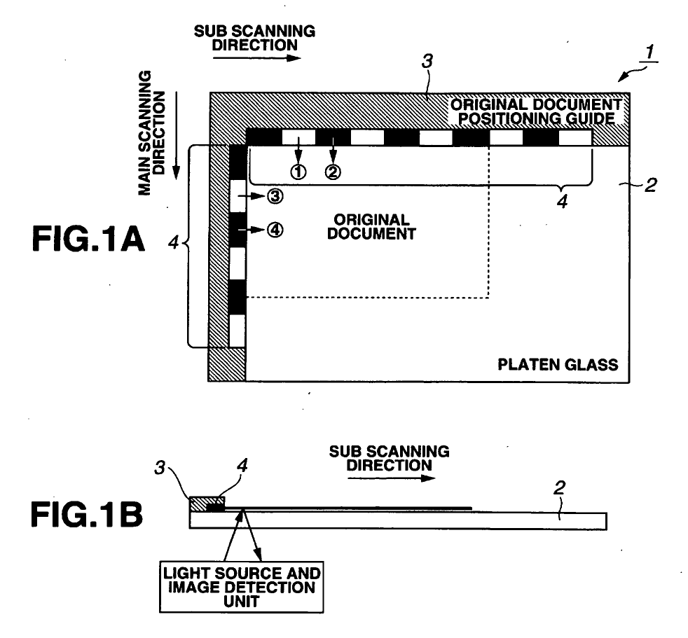

FIG. 1A is a diagram showing an example of an appearance of an original document holder 1 for setting an original document to be read by the image reading device.

As shown in FIG. 1A, the original document holder includes a platen glass 2, which is a transparent member 2 formed with a plate-like transparent glass, and an L shape original document positioning guide 3 provided to the platen glass 2. It should be noted that the original document is positioned with the support of an edge portion of the original document positioning guide 3.

It should be noted that the original document holder 1 includes, in its inside, a light source that emits light to the platen glass 2 having a carriage that reciprocatingly moves in a sub scanning direction and opposite direction thereto, and an image detection unit, such as CCD line sensor, that receives light emitted from the light source and reflected on the original document placed on the platen glass 2 or a cover (not shown) for holding the original document, and sequentially outputs image signals in a main scanning direction (hereinafter, these components are collectively referred to as a reading section).

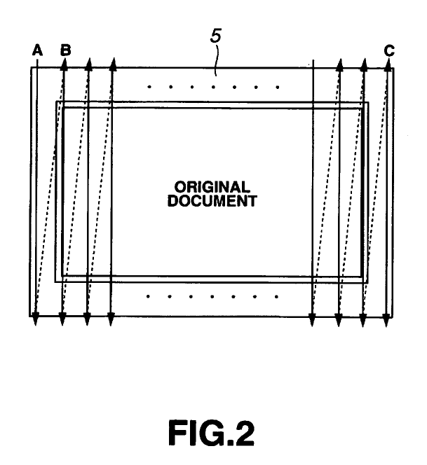

The image detection unit in the reading section sequentially outputs image signals of the original document along an arrow shown in FIG. 2. As shown in FIG. 2, the image detection unit sequentially outputs the image signals from the upper edge to the lower edge (main scanning direction) of an outside line (arrow A in FIG. 2) located on a left end of the original document. After sequentially outputting all the image signals on this line, the image detection unit sequentially outputs image signals from the upper edge to the lower edge (main scanning direction) of the next line (arrow B in FIG. 2) on the right-hand side. After repeating the processing above and outputting all the image signals on the outside line of the right edge of the original document, the image detection unit ends the output of the image signals. It should be noted that, as shown in FIG. 2, the image detection unit outputs not only the image signals within the area of the original document, but also image signals within an area 5 located outside the original document.

Next, as shown in FIGS. 1A and 1B, a white pattern and black pattern 4 is marked along an edge portion of the backside of the original document positioning guide 3, in other words, the side which receives the light emitted from the light source of the reading section. It should be noted that, in FIG. 1A, the white pattern and black pattern 4 is marked for a large portion of the original document positioning guide 3. However, it is sufficient to mark only one set of the white pattern and black pattern 4 within a range of the minimum original document size. Additionally, colors of the pattern are not necessarily limited to white and black. Furthermore, the white pattern and the black pattern are not necessarily next to each other.

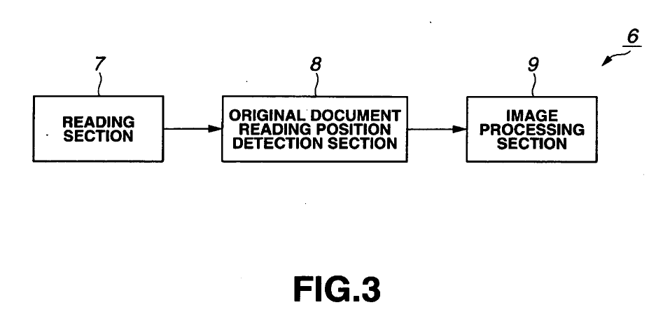

FIG. 3 is a diagram showing an example of a functional configuration of the image reading device 6.

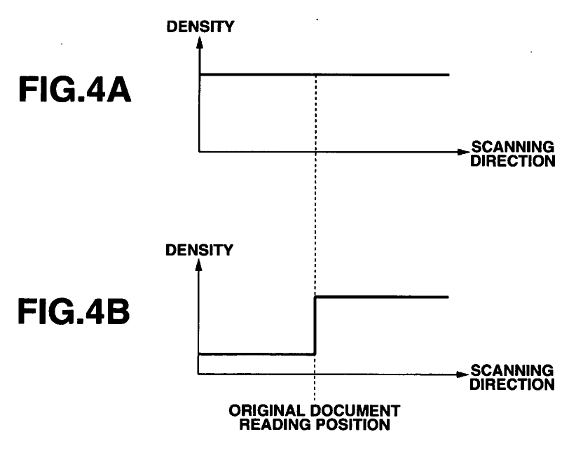

As shown in FIG. 4, the image reading device 6 includes a reading section 7, an original document reading position detection section 8 and an image processing section 9.

The original document reading position detection section 8 detects a position where the original document is read on the basis of image signals outputted from the reading section 7.

The image processing section 9 generates a read image of the original document based on the image signals outputted from the reading section 7, and performs various kinds of image processing to the generated read image.

It should be noted that it may be possible to employ a configuration in which an original document reading position detection program having a function of the original document reading position detection section 8 described above is incorporated in a general image reading device 6. In this case, the original document reading position detection program is stored in a storage in the image reading device 6, and a CPU in the image reading device 6 implements the original document reading position detection program stored in the storage. Additionally, the original document reading position detection program may be provided, for example, by being stored in various memories, an optical disc or other recording media, and may be distributed, for example, through a communication line, a network and so on.

Next, a process of detecting the original document reading position implemented by the original document reading position detection section 8 will be described.

FIGS. 4A and 4B are diagrams explaining an example of processing of detecting the original document reading position when the image reading device reads an original document having a white background.

FIG. 4A is a graph showing a change in values (hereinafter, referred to as “density”; high density represents white, and low density represents black) of the image signal in a scanning direction from the white pattern to a white original document (arrow 1 or 3 in FIG. 1A). Since the light emitted from the light source and reflected on the white pattern is high density while the light emitted from the light source and reflected on the white original document is high density, the density at the time of scanning from the white pattern to the white original document is high and stable as shown in FIG. 4A.

FIG. 4B is a graph showing a change in the density in a scanning direction from the black pattern to the white original document (arrow 2 or 4 in FIG. 1A). Since the light emitted from the light source and reflected on the black pattern is low density while the light emitted from the light source and reflected on the white original document is high density, the density at the time of scanning from the black pattern to the white original document changes from low to high as shown in FIG. 4B.

The original document reading position detection section 8 determines a position where the change occurs in the graph shown in FIG. 4B as an original document reading position.

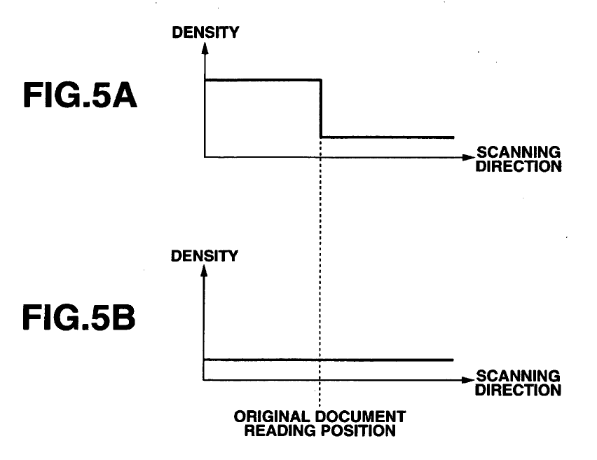

FIGS. 5A and 5B are diagrams explaining an example of processing of detecting the original document reading position when the image reading device reads an original document having a black background.

FIG. 5A is a graph showing a change in the density in a scanning direction from the white pattern to the black original document (arrow 1 or 3 in FIG. 1A). Since the light emitted from the light source and reflected on the white pattern is high density while the light emitted from the light source and reflected on the black original document is low density, the density at the time of scanning from the white pattern to the black original document changes from high to low as shown in FIG. 5A.

FIG. 5B is a graph showing a change in the density in a scanning direction from the black pattern to the black original document (arrow 2 or 4 in FIG. 1A). Since the light emitted from the light source and reflected on the black pattern is low density while the light emitted from the light source and reflected on the black original document is low density, the density at the time of scanning from the black pattern to the black original document is low and stable as shown in FIG. 5B.

The original document reading position detection section 8 determines a position where the change occurs in the graph shown in FIG. 5A as an original document reading position.

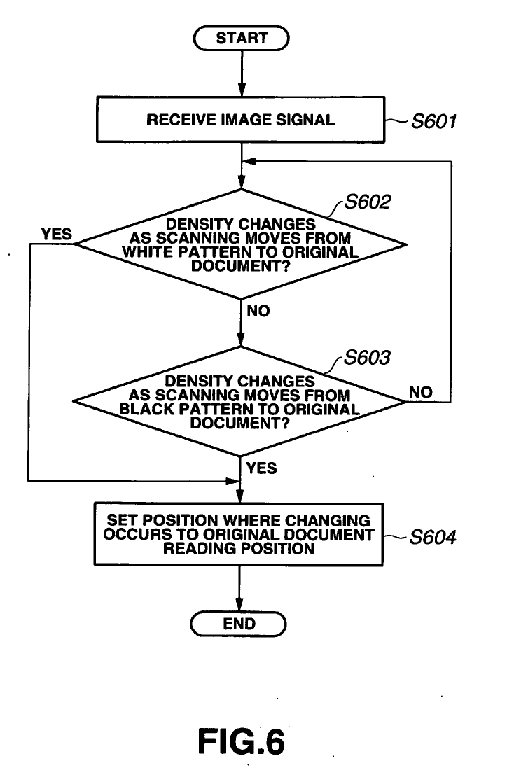

Next, an example flow of processing of detecting the original document reading position implemented by the original document reading position detection section 8 will be described with reference to a flowchart shown in FIG. 6.

Upon receiving the image signals outputted from the reading section (S601), the original document reading position detection section monitors a change in the density in a scanning direction from the white pattern to the original document (S602). If the density in the scanning direction from the white pattern to the original document does not change (NO in S602), the processing proceeds to S603. If the density in the scanning direction from the white pattern to the original document changes from high to low (YES in S602), the processing proceeds to S604.

If the density in the scanning direction from the white pattern to the original document does not change (NO in S602), the original document reading position detection section monitors a change in the density in a scanning direction from the black pattern to the original document (S603). If the density in the scanning direction from the black pattern to the original document does not change (NO in S603), the processing returns to S602. If the density in the scanning direction from the black pattern to the original document changes from low to high (YES in S603), the processing proceeds to S604.

Then, the original document reading position detection section determines a position where the change occurs as an original document reading position (S604), and ends the processing.

It should be noted that positions where the white and the black patterns are marked are not necessarily limited to the edge portion of the original document positioning guide. It may be possible to make the marking to a location in a distance from the edge portion. If the distance from the edge portion to the marking is known, the original document reading position can be detected based on the known distance.

The foregoing description of the exemplary embodiment of the present invention is provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image reading device, comprising:
an original document reading section that emits light to an original document and in the vicinity of the original document, receives reflected light and outputs image signals;
an original document positioning guide that has at least a first color and a second color on a side receiving the light emitted from the original document reading section, and is used for settling a position of the original document;
a detection section that monitors a first image signal in a scanning direction from the first color to the original document and a second image signal in a scanning direction from the second color to the original document, and detects a position for extracting the image signals corresponding to light reflected on the original document on the basis of a change occurring in either of the first image signal or the second image signal.

2. The image reading device according to claim 1, wherein the at least first color and second color are provided along an edge portion of the original document positioning guide.

3. The image reading device according to claim 1, wherein the at least first color and second color are provided within a size of the original document to be read.

4. The image reading device according to claim 1, wherein the at least first color and second color are marked on the side receiving the light emitted from the original document reading section.

5. The image reading device according to claim 1, wherein, when the at least first color and second color are provide at a distance from an edge portion of the original document positioning guide, the position for extracting the image signals is detected taking the distance from the edge portion into consideration.

6. A computer readable recoding medium storing a program that causes the computer to execute a process of image reading, the process comprising:
emitting light to an original document and in the vicinity of the original document;
receiving reflected light;
outputting image signals;
settling a position of the original document;
monitoring a first image signal and a second image signal, at least a first color and a second color being provided on the side receiving the emitted light, a scanning direction of the first image signal being from the first color to the original document and a scanning direction of the second image signal being from the second color to the original document; and
detecting a position for extracting image signals corresponding to light reflected on the original document on the basis of a change occurring in either of the first image signal or the second image signal.

7. The computer readable recoding medium according to claim 6, wherein the at least first color and second color are provided along an edge portion of an original document positioning guide.

8. The computer readable recoding medium according to claim 6, wherein the at least first color and second color are provided within a size of the original document to be read.

9. The computer readable recoding medium according to claim 6, wherein the at least first color and second color are marked on a side receiving the light emitted from the original document reading section.

10. The computer readable recoding medium according to claim 6, wherein, when the first color and the second color are provide at a distance from the edge portion of the original document positioning guide, the position for extracting the image signals is detected taking the distance from the edge portion into consideration.

11. An image reading method, comprising:
emitting light to an original document and in the vicinity of the original document;
receiving reflected light;
outputting image signals;
settling a position of the original document;
monitoring a first image signal and a second image signal, at least a first color and a second color being provided on the side receiving the emitted light, a scanning direction of the first image signal being from the first color to the original document and a scanning direction of the second image signal being from the second color to the original document; and
detecting a position for extracting image signals corresponding to light reflected on the original document on the basis of a change occurring in either of the first image signal or the second image signal.

12. A computer data signal embodied in a carrier wave for enabling a computer to perform a process for image reading, the process comprising:
emitting light to an original document and in the vicinity of the original document;
receiving reflected light;
outputting image signals;
settling a position of the original document;
monitoring a first image signal and a second image signal, at least a first color and a second color being provided on the side receiving the emitted light, a scanning direction of the first image signal being from the first color to the original document and a scanning direction of the second image signal being from the second color to the original document; and
detecting a position for extracting image signals corresponding to light reflected on the original document on the basis of a change occurring in either of the first image signal or the second image signal.
